(19) United States
(12) Patent Application Publication
(10) Pub. No.: US 2013/0011723 A1
(43) Pub. Date: Jan. 10, 2013

(54) ENERGY STORAGE CASE AND ENERGY STORAGE INCLUDING THE SAME

(75) Inventors: Yeong Su Cho, Gyeonggi-do (KR); Kang Heon Hur, Gyeonggi-do (KR); Bae Kyun Kim, Gyeonggi-do (KR)

(73) Assignee: SAMSUNG ELECTRO-MECHANICS CO., LTD., Suwon (KR)

(21) Appl. No.: 13/541,102

(22) Filed: Jul. 3, 2012

(30) Foreign Application Priority Data
Jul. 8, 2011 (KR) 10-2011-0067895

(51) Int. Cl. H01M 2/26; H01G 9/008; H01G 9/155

(52) U.S. Cl. 429/179; 361/502

(57) ABSTRACT

Disclosed herein are an energy storage case includes: a housing including a reception part in which an energy storage cell and an electrolyte are received; a cover part coupled to the housing and including two through-holes penetrating through both surfaces thereof; a lead connection part including a fusing part to which one end of a current collector of the energy storage cell is fused and a coupling part formed with a first screw part; and an external lead part including a second screw part coupled to the first screw part and a head part having a rectangular shape.

### CROSS REFERENCE(S) TO RELATED APPLICATIONS

This application claims the benefit under 35 U.S.C. Section 119 of Korean Patent Application Serial No. 10-2011-0067895, entitled “Energy Storage Case and Energy Storage Including the Same” filed on Jul. 8, 2011, which is hereby incorporated by reference in its entirety into this application.

### BACKGROUND OF THE INVENTION

1. Technical Field

The present invention relates to an energy storage case and an energy storage including the same.

2. Description of the Related Art

In order to stably supply power to various electric and electronic devices, an energy storage such as a secondary battery, a supercapacitor, or the like, has been used.

Since the supercapacitor is excellent in view of energy input and output as compared to the secondary battery, the use of the supercapacitor as a back-up power supply which is an auxiliary power supply operated at the time of temporary power failure has increased. In addition, since the supercapacitor has a more excellent charging and discharging efficiency and lifespan as compared to the secondary battery and a relatively wide usable temperature and voltage range, does not require maintenance, and is environment-friendly, the supercapacitor has also been studied as a use for substituting for the secondary battery.

In order to utilize these advantages of the supercapacitor, an application range of the supercapacitor has recently increased to a system requiring an independent power supply, a system controlling temporally generated overload, and the like.

Meanwhile, resistance characteristics of the supercapacitor are determined by several factors, one of which may be a connection state between a current collector and an external terminal.

In order to connect a bundle of current collectors or a lead wire and an external terminal to each other in an energy storage such as the supercapacitor, a riveting scheme, an ultrasonic fusing scheme, or the like, has been mainly used.

In the riveting scheme, the bundle of current collectors or the lead wire and the external terminal to each other are physically compressed to each other using a rivet. However, this scheme has a disadvantage in that contact resistance in each electrode increases according to a surface state of a contact surface.

Further, in the ultrasonic fusing scheme, the lead wire and the external electrode are fused to each other using an ultrasonic wave. However, this scheme has a disadvantage in that a fine crack is generated in the external electrode due to vibration generated during an ultrasonic fusing process, such that contact resistance increases.

Meanwhile, in general external terminals according to the related art, a head part has a circular shape and a size significantly smaller than a width of a cover part of a case. Therefore, in the case in which a plurality of supercapacitor modules connected in series or parallel with each other are used, when the external terminals of each of the supercapacitor modules are electrically connected to each other using a separate connection unit, a contact area between the head part of the external terminal and the connection unit is small, such that contact resistance increases.

### SUMMARY OF THE INVENTION

An object of the present invention is to provide an energy storage case which a lead wire and an external terminal are connected to each other in an ultrasonic fusing scheme so that a crack is not generated in the external terminal and a contact area between a head part of the external terminal and a connection unit is increased to improve resistance characteristics.

Another object of the present invention is to provide an energy storage having improved resistance characteristics by including the energy storage case.

According to an exemplary embodiment of the present invention, there is provided an energy storage case including: a housing including a reception part in which an energy storage cell and an electrolyte are received; a cover part coupled to the housing and including two through-holes penetrating through both surfaces thereof; a lead connection part including a fusing part to which one end of a current collector of the energy storage cell is fused using an ultrasonic wave and a coupling part formed with a first screw part; and an external lead part including a second screw part coupled to the first screw part and a head part having a rectangular shape.

An external terminal may be defined by coupling the lead connection part and the external lead part to each other.

The cover part may further include two recess parts recessed inwardly, and the through-holes may be formed in the recess parts.

The external lead part may further include a guide part provided between the second screw part and the head part, the cover part may further include two recess parts having a shape corresponding to that of the guide part and recessed inwardly, and the through-holes may be formed in the recess parts.

The energy storage case may further include an O-ring provided between the recess part and the guide part.

According to another exemplary embodiment of the present invention, there is provided an energy storage case including: a housing including a reception part in which an energy storage cell and an electrolyte are received; a cover part coupled to the housing and including two through-holes penetrating through both surfaces thereof and a gas discharging unit; a lead connection part including a fusing part to which one end of a current collector of the energy storage cell is fused and a coupling part formed with a first screw part; and an external lead part including a second screw part coupled to the first screw part and a head part having a rectangular shape, wherein it is assumed that a transversal length of the cover part is A and a longitudinal length thereof is B, a transversal length of the head part is a and a longitudinal length thereof is b, and a transversal length of the gas discharging unit is c, all of conditions of A≧B, A≧2a+c, B≧b, and B>c are satisfied.

The cover part may further include two recess parts recessed inwardly, and the through-holes may be formed in the recess parts.

The external lead part may further include a guide part provided between the second screw part and the head part, the cover part may further include two recess parts having a shape corresponding to that of the guide part and recessed inwardly, and the through-holes may be formed in the recess parts.

The energy storage case may further include an O-ring provided between the recess part and the guide part.

According to still another exemplary embodiment of the present invention, there is provided an energy storage including: the energy storage cell and the electrolyte provided in the energy storage case as described above, wherein one end of the current collector of the energy storage cell is coupled to the fusing part.

### BRIEF DESCRIPTION OF THE DRAWINGS

FIG. 1 is an exploded perspective view showing an energy storage according to an exemplary embodiment of the present invention;

FIG. 2 is an assembled perspective view showing the energy storage according to the exemplary embodiment of the present invention;

FIG. 3 is a plan view of FIG. 2; and

FIG. 4 is a plan view showing an energy storage according to the related art.

### DESCRIPTION OF THE PREFERRED EMBODIMENTS

Various advantages and features of the present invention and methods accomplishing thereof will become apparent from the following description of embodiments with reference to the accompanying drawings. However, the present invention may be modified in many different forms and it should not be limited to the embodiments set forth herein. These embodiments may be provided so that this disclosure will be thorough and complete, and will fully convey the scope of the invention to those skilled in the art. Like reference numerals throughout the description denote like elements.

Terms used in the present specification are for explaining the embodiments rather than limiting the present invention. Unless explicitly described to the contrary, a singular form includes a plural form in the present specification. The word “comprise” and variations such as “comprises” or “comprising,” will be understood to imply the inclusion of stated constituents, steps, operations and/or elements but not the exclusion of any other constituents, steps, operations and/or elements.

Hereinafter, a configuration and an operation of exemplary embodiments of the present invention will be described in more detail with reference to the accompanying drawings.

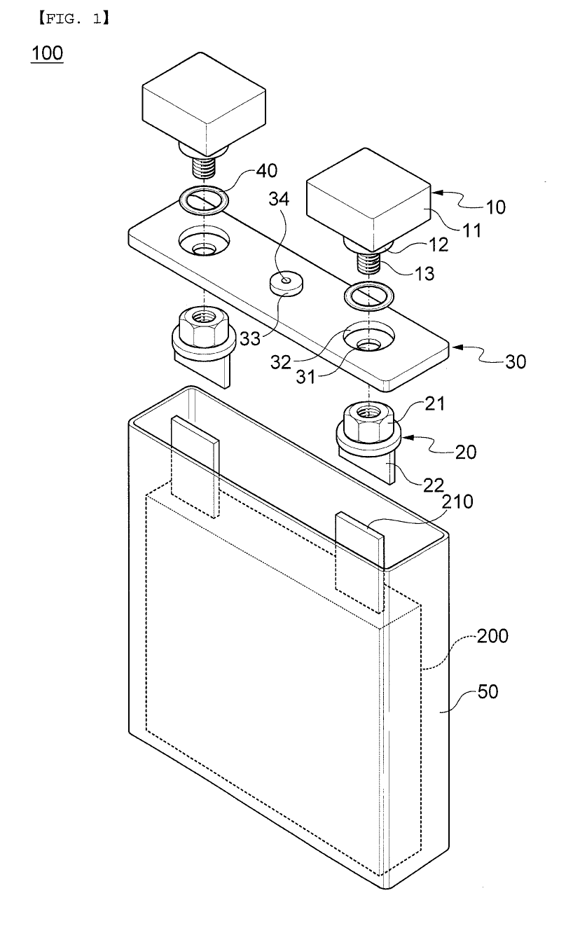

FIG. 1 is an exploded perspective view showing an energy storage 100 according to an exemplary embodiment of the present invention; and

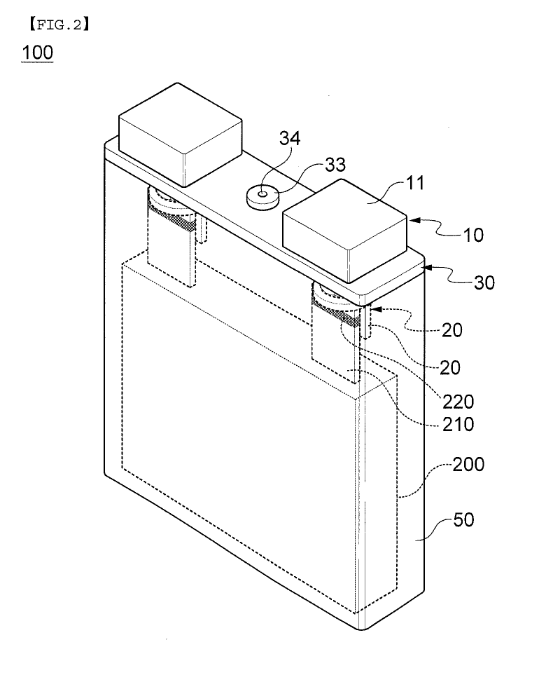

FIG. 2 is an assembled perspective view showing the energy storage 100 according to the exemplary embodiment of the present invention.

Referring to FIGS. 1 and 2, the energy storage 100 according to the exemplary embodiment of the present invention may include an energy storage case, an energy storage cell 200, and an electrolyte (not shown).

Here, the energy storage cell 200 may be a secondary battery or a supercapacitor cell.

Meanwhile, the energy storage case according to the exemplary embodiment of the present invention may include a housing 50, a cover part 30, a lead connection part 20, and an external lead part 10.

The housing 50 may be formed in a rectangular shape, or the like, and have the energy storage cell 200 and the electrolyte received in an internal space thereof.

The cover part 30 is coupled to the housing 50 to allow the energy storage cell 200 and the electrolyte to be received in the housing 50 so as to be closed.

In addition, the cover part 30 may be provided with a gas discharging unit 33 discharging gas generated in the energy storage case. Here, the gas discharging unit 33 may be implemented in various shapes and allow the gas to be discharged through an outlet 34 when pressure in the energy storage 100 become larger than a preset pressure.

In addition, the cover part 30 may be provided with two recess parts 32 recessed inwardly.

Here, each recess part 32 may have a through-hole 31 formed therein.

The lead connection part 20 and the external lead part 10 may be coupled to each other to serve as an external terminal.

The lead connection part 20 may include a fusing part 22 and a first screw part 21. The fusing part 22 and one end of a current collector or the lead wire 210 of the energy storage cell 200 may be fused to each other in an ultrasonic fusing scheme.

The first screw part 21 may be formed of a female screw or a male screw.

The external lead part 10 may include a second screw part 13, a guide part 12, and a head part 11.

The second screw part 13, which is a part screw-coupled to the first screw part 21, may be implemented by a male screw in the case in which the first screw part 21 is implemented by a female screw and be implemented by a female screw in the case in which the first screw part 21 is implemented by a male screw.

The guide part 12, which is a part inserted into the recess part 32, may be implemented to have a shape corresponding to that of the recess part 32. The guide part 12 and the recess part 32 may have a circular shape so that the first screw part 21 and the second screw part 13 may be smoothly coupled to each other.

In addition, an O-ring 40 may be provided on a contact surface between the guide part 12 and the recess part 32 to increase tightness between inner and outer portions of the energy storage case.

The head part 11 may be formed in a rectangular shape on the guide part 12.

Hereinafter, a process of assembling the energy storage 100 according to the exemplary embodiment of the present invention will be described with reference to FIGS. 1 and 2.

First, a current collector itself of the energy storage cell 200 or a separate lead wire 210 is fused to the fusing part 22 in the ultrasonic scheme.

Next, the second screw part 12 of the external lead part 10 and the first screw part 21 of the lead connection part 20 are screw-coupled to each other, having the cover part 30 therebetween.

Since the external lead part 10 and the lead connection part 20 may be coupled to each other after the fusing process as described above, a problem that a crack is generated in an external terminal implemented by coupling the external lead part 10 and the lead connection part 20 to each other due to vibration in an ultrasonic fusing process may be solved.

Finally, the energy storage cell 200 is inserted into the housing 50, the electrolyte is injected thereinto, and the cover part 30 and the housing 50 are then coupled to each other so as to be closed.

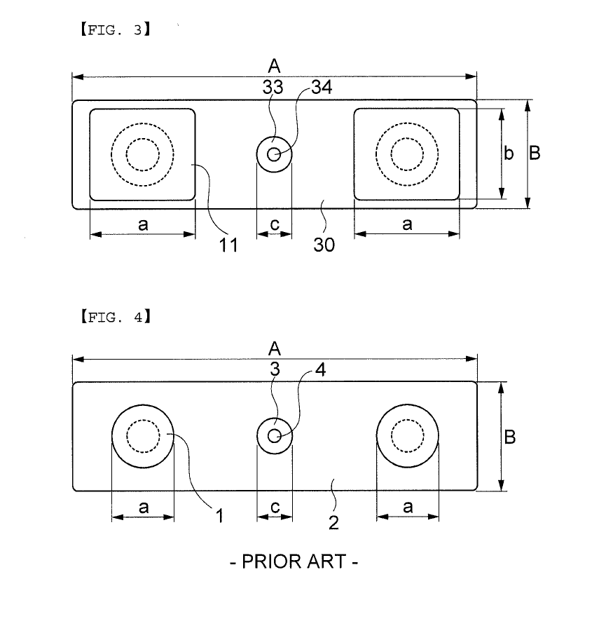

FIG. 3 is a plan view of FIG. 2; and FIG. 4 is a plan view showing an energy storage according to the related art.

Since an existing external terminal 1 is mainly implemented in a circular shape, there is a limitation in increasing an area of an upper surface of the external terminal 1.

Referring to FIGS. 3 and 4, a transversal length of the cover part 30 is A and a longitudinal length thereof is B, a transversal length of the head part 11 is a and a longitudinal length thereof is b, and a transversal length of the gas discharging unit 33 is c.

In this case, a and b are determined so as to satisfy all of conditions of A≧ B, A≧2a+c, B≧b, and B>c to form the head part 11, thereby making it possible to maximize an area of the head part 11.

For example, when it is assumed that A=100 mm, B=20 mm, and c=6 mm, a maximum cross-section area of the external terminal may not exceed 314 mm² in a structure as shown in FIG. 4.

However, in the case energy storage 100 according to the exemplary embodiment of the present invention as shown in FIG. 3, a cross sectional area of the terminal head part 11 may become 940 mm².

As described above, since a surface area of the upper surface of the external terminal may be maximized, in the case in which a plurality of energy storage modules connected in series or parallel with each other are used, contact resistance is reduced as compared to the case according to the related art in electrically connecting each external terminal of the energy storage modules to each other using a separate connection unit, thereby making it possible to improve resistance characteristics of the energy storage 100 as compared to the case according to the related art.

As set forth above, with the energy storage case according to the exemplary embodiment of the present invention, the contact resistance between the current collector and the external terminal is reduced as compared to the case according to the related art, thereby making it possible to improve the resistance characteristics of the energy storage as compared to the case according to the related art.

In addition, since the surface area of the external terminal may be maximized, in the case in which the plurality of energy storage modules connected in series or parallel with each other are used, the contact resistance is reduced as compared to the case according to the related art in electrically connecting each external terminal of the energy storage modules to each other using the separate connection unit, thereby making it possible to improve the resistance characteristics of the energy storage as compared to the case according to the related art.

The present invention has been described in connection with what is presently considered to be practical exemplary embodiments. Although the exemplary embodiments of the present invention have been described, the present invention may be also used in various other combinations, modifications and environments. In other words, the present invention may be changed or modified within the range of concept of the invention disclosed in the specification, the range equivalent to the disclosure and/or the range of the technology or knowledge in the field to which the present invention pertains. The exemplary embodiments described above have been provided to explain the best state in carrying out the present invention. Therefore, they may be carried out in other states known to the field to which the present invention pertains in using other inventions such as the present invention and also be modified in various forms required in specific application fields and usages of the invention. Therefore, it is to be understood that the invention is not limited to the disclosed embodiments. It is to be understood that other embodiments are also included within the spirit and scope of the appended claims.

What is claimed is:

1. An energy storage case comprising:
a housing including a reception part in which an energy storage cell and an electrolyte are received;
a cover part coupled to the housing and including two through-holes penetrating through both surfaces thereof;
a lead connection part including a fusing part to which one end of a current collector of the energy storage cell is fused using an ultrasonic wave and a coupling part formed with a first screw part; and
an external lead part including a second screw part coupled to the first screw part and a head part having a rectangular shape.

2. The energy storage case according to claim 1, wherein the cover part further includes two recess parts recessed inwardly, and the through-holes are formed in the recess parts.

3. The energy storage case according to claim 1, wherein the external lead part further includes a guide part provided between the second screw part and the head part, and
wherein the cover part further includes two recess parts having a shape corresponding to that of the guide part and recessed inwardly, and the through-holes are formed in the recess parts.

4. The energy storage case according to claim 3, further comprising an O-ring provided between the recess part and the guide part.

5. An energy storage case comprising:
a housing including a reception part in which an energy storage cell and an electrolyte are received;
a cover part coupled to the housing and including two through-holes penetrating through both surfaces thereof and a gas discharging unit;
a lead connection part including a fusing part to which one end of a current collector of the energy storage cell is fused and a coupling part formed with a first screw part; and
an external lead part including a second screw part coupled to the first screw part and a head part having a rectangular shape, wherein it is assumed that a transversal length of the cover part is A and a longitudinal length thereof is B, a transversal length of the head part is a and a longitudinal length thereof is b, and a transversal length of the gas discharging unit is c, all of conditions of A≧B, A≧2a+c, and B≧c are satisfied.

6. The energy storage case according to claim 5, wherein the cover part further includes two recess parts recessed inwardly, and the through-holes are formed in the recess parts.

7. The energy storage case according to claim 6, wherein the external lead part further includes a guide part provided between the second screw part and the head part, and
wherein the cover part further includes two recess parts having a shape corresponding to that of the guide part and recessed inwardly, and the through-holes are formed in the recess parts.

8. The energy storage case according to claim 7, further comprising an O-ring provided between the recess part and the guide part.

9. An energy storage comprising:
the energy storage cell and the electrolyte provided in the energy storage case according to claim 1,
wherein one end of the current collector of the energy storage cell is coupled to the fusing part.

10. An energy storage comprising:
the energy storage cell and the electrolyte provided in the energy storage case according to claim 1,
wherein one end of the current collector of the energy storage cell is coupled to the fusing part.

11. An energy storage comprising:
the energy storage cell and the electrolyte provided in the energy storage case according to claim 3,
wherein one end of the current collector of the energy storage cell is coupled to the fusing part.

12. An energy storage comprising:
the energy storage cell and the electrolyte provided in the energy storage case according to claim 4,
wherein one end of the current collector of the energy storage cell is coupled to the fusing part.

13. An energy storage comprising:
the energy storage cell and the electrolyte provided in the energy storage case according to claim 5,
wherein one end of the current collector of the energy storage cell is coupled to the fusing part.

14. An energy storage comprising:
the energy storage cell and the electrolyte provided in the energy storage case according to claim 6,
wherein one end of the current collector of the energy storage cell is coupled to the fusing part.

15. An energy storage comprising:
the energy storage cell and the electrolyte provided in the energy storage case according to claim 7,
wherein one end of the current collector of the energy storage cell is coupled to the fusing part.
